(19) United States
(12) Patent Application Publication
(10) Pub. No.: US 2007/0061398 A1
(43) Pub. Date: Mar. 15, 2007

(54) Controlling content sharing during a tele-conferencing session

(75) Inventor: Mika Forssell, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/224,701

(22) Filed: Sep. 12, 2005

(51) Int. Cl. G06F 15/16

(52) U.S. Cl. 709/204

(57) ABSTRACT

A method is shown for controlling content sharing towards a terminal during a teleconferencing session. The method comprises: establishing the teleconferencing session between at least a first and a second terminal; selecting, for the first terminal, a communication link having suitable link characteristics for sharing desired content during the teleconferencing session; observing, in the first terminal, changes occurring in the link characteristics of the communication link or in internal characteristics of the first terminal; in response to at least one predetermined parameter value of said link characteristics or said internal characteristics of the first terminal reaching a predetermined threshold, changing a conferencing capability of the first terminal. Optionally, an indication is then transmitted to at least one party of the teleconferencing session or to a conferencing bridge that the content sharing towards the first terminal is to be limited according to a rule included in said indication.

### FIELD OF THE INVENTION

The present invention relates to teleconferencing services, and more particularly to controlling content sharing during a teleconferencing session.

### BACKGROUND OF THE INVENTION

Various audio and video conferencing services have been available for a long time, particularly in traditional landline circuit-switched telecommunications networks. Teleconferencing systems can be divided into distributed and centralized systems, of which the latter have turned out to be more advantageous in providing teleconferencing services, considering the service providers and the implementation of terminals. In a centralized audio conference service, the teleconferencing system comprises a conference bridge and several terminals that communicate with it. The conference bridge combines the audio signals from the terminals and transmits the combined signal to the terminal for reproduction. In a distributed system, the terminals themselves comprise the required intelligence to process the audio signals from other terminals, and a conference bridge is not necessarily needed, even though a distributed system may comprise a conference bridge, wherein some teleconferencing processing is carried out.

Various teleconferencing systems for mobile terminals (i.e. mobile conferencing) are currently developed. In addition to traditional voice services, mobile terminals are also provided with various data applications. Mobile terminals are capable of processing different types of document files and video files, downloading software files, etc. When developing mobile conferencing applications, it needs to be considered that a terminal user may also want to share data application content with other participants of a conference call.

For example, US patent application US2004/034723 A1 discloses a converged conferencing appliance having at least one voice port and one data port for managing multi-device conferences allowing multiple participants to concurrently connect diverse devices over various types of communication networks. Participants may participate in integrated voice, data and video conferences by simultaneously connecting from one or more devices, such as traditional phones, mobile phones, voice and data capable smart phones, computers, VoIP devices, wireless devices and other intelligent handheld devices.

However, this prior art arrangement has the serious shortcoming that the multiradio properties of the current and future mobile terminals are not considered at all. A multiradio terminal is able to use different access technologies (both wireless and wireline) for accessing a network, like company intranet or public Internet. When a multiradio terminal participates in mobile conferencing, the terminal tries to choose the most optimum access technology to be used. For an ordinary user, the optimal criteria might be bitrate and cost, for an enterprise user the criteria might be bitrate and reliability. After connecting to a conferencing meeting, the user is able to listen and speak and also share content, such as text documents, presentation slides, SW files etc.

A problem involved in mobile conferencing with multiradio terminals is that when the network connection type changes to another access technology, also the quality of service (QoS) parameters of the connection typically change. If the QoS of the connection degrades significantly, the user of the terminal may wish to access the mobile conference only in a limited way. For example, if the bitrate of the connection degrades under a given threshold or the connection price exceeds a given threshold, the user might want to sustain the speech connection (circuit-switched or VoIP) but to deactivate the sharing (sending and receiving) of large contents of data. Moreover, a change in link characteristics, either in a used access network or a core network, may cause changes in a transport protocol or in available service, which in turn may affect to the sharing of content. Furthermore, some internal characteristics of the terminal, like battery status or available CPU power, may change during a conferencing meeting such that the sharing of large contents of data may become undesirable. Unfortunately, current mobile conferencing solutions do not provide any means for such multi-access awareness or terminal capability awareness during a conference call.

### SUMMARY OF THE INVENTION

Now there is invented an improved method and technical equipment implementing the method, by which the varying conditions of a conferencing meeting are better taken into account in the control of content sharing. Various aspects of the invention include a method, a system, a terminal device and a computer program, which are characterized by what is stated in the independent claims. Various embodiments of the invention are disclosed in the dependent claims.

According to a first aspect, a method according to the invention is based on the idea of controlling content sharing towards a terminal during a teleconferencing session such that the teleconferencing session is first established between at least a first and a second terminal. Then the first terminal selects a communication link having suitable link characteristics for sharing desired content during the teleconferencing session, and observes possible changes occurring in the link characteristics of the communication link or in internal characteristics of the first terminal. If at least one predetermined parameter value of said link characteristics or said internal characteristics of the first terminal reaches a predetermined threshold, the first terminal changes its conferencing capability.

According to an embodiment, the first terminal transmits an indication to at least one party of the teleconferencing session or to a conferencing bridge that the content sharing towards the first terminal is to be limited according to a rule included in said indication.

According to an embodiment, the method further comprises: determining the link characteristics of the communication link in connection with establishing the teleconferencing session; and in response to at least one predetermined parameter value of said link characteristics or in said internal characteristics of the first terminal exceeding predetermined threshold, transmitting an indication to at least one party of the teleconferencing session or to the conferencing bridge that enhanced content sharing towards the first terminal is to be applied.

According to an embodiment, the method further comprises: determining the link characteristics of the communication link with assistance of at least one party of the teleconferencing session.

According to an embodiment, the method further comprises: in response to a party of the teleconferencing session having content to be shared, sharing of which content towards the first terminal being refused by the rule, receiving, in the first terminal, a request from said party or from the conference bridge for allowing transmission of the particular content to the first terminal.

According to an embodiment, the method further comprises: in response to at least one predetermined parameter value of said link characteristics or said internal characteristics of the first terminal exceeding predetermined threshold, refraining content sharing from the first terminal towards other parties of the teleconferencing session.

According to an embodiment, the parameter value of said link characteristics include at least one of the following: used access technology, connection type (circuit/packet switched), one or more quality of service parameters, and time and/or date of the conferencing session.

According to an embodiment, the parameter value of said link characteristics include at least one of the following security issues: existence of a security mechanism on the established communication link, the location of the access point of the communication link, the location of the terminal and originating network address of shared content directed towards the terminal.

According to an embodiment, the parameter value of said internal characteristics of the terminal include at least one of the following: battery status, available CPU power, available memory space, docking station connected/not connected, battery charger connected/not connected, available peripheral devices, and occurrence of a predefined user activity.

The arrangement according to the invention provides significant advantages. The multi-access awareness provided by the embodiments takes into account the possibly changing link characteristics of a multi-access terminal, thus facilitating to control the content sharing to better reflect the current link characteristics. In addition to link characteristics, the embodiments also provide means for controlling the content sharing according to (either stable or varying) characteristics of the terminal, which characteristics also reflect to the smoothness of the content sharing. As a result of these control means of the embodiments, the content sharing during a teleconferencing session can advantageously be enhanced and optimized.

According to a second aspect, there is provided a teleconferencing system comprising a conference bridge, wherein the above method is implemented.

According to a third aspect, there is provided a terminal comprising: means for sharing content during a teleconferencing session; means for establishing the teleconferencing session with at least a second terminal; means for selecting a communication link having suitable link characteristics for sharing desired content during the teleconferencing session; means for observing changes occurring in the link characteristics of the communication link or in internal characteristics of the first terminal; and means, responsive to at least one predetermined parameter value of said link characteristics or said internal characteristics of the first terminal reaching a predetermined threshold, for changing its conferencing capability.

According to an embodiment, the terminal further comprises means for transmitting an indication to a conference bridge or to a party of the teleconferencing session that the content sharing towards the first terminal is to be limited according to a rule included in said indication.

According to a fourth aspect, there is provided a computer program product, stored on a computer readable medium and executable in a data processing device, for operating the terminal to control content sharing during a teleconferencing session.

### LIST OF DRAWINGS

In the following, various embodiments of the invention will be described in more detail with reference to the appended drawings, in which

FIG. 1 shows a terminal according to an embodiment of the invention in a simplified block diagram;

FIG. 2 shows a signalling chart of a content sharing controlling method according to an embodiment of the invention;

FIG. 3 shows a signalling chart of a content sharing controlling method according to another embodiment of the invention; and

FIG. 4 shows a flow chart of a terminal operation in controlling content sharing according to an embodiment of the invention.

### DESCRIPTION OF EMBODIMENTS

FIG. 1 shows a wireless terminal MS, such as a mobile station, which comprises means for using different radio access technologies in its communication. A mobile station generally refers to a device capable of data transfer with a public land mobile network, such as a GSM/GPRS network and/or a third-generation (e.g. 3GPP) network via WCDMA access technology. The most recent mobile station models typically employ several of the following systems and frequency ranges: EGSM 900 (880 to 960 MHz), GSM 1800 (1710 to 1880 MHz), GSM 1900 (1850 to 1990 MHz), WCDMA 2000 (1920 to 2170 MHz), US-GSM 850 (824 to 894 MHz), US-WCDMA 1900 (1850 to 1990 MHz) and US-WCDMA 1700/2100 (Tx 1710 to 1770 MHz, Rx 2110 to 2170 MHz). Most of these systems offer, in addition to traditional circuit-switched services, also packet-switched data connections. Moreover, many of the recent mobile station models are capable of WLAN access e.g. via a wireless local area network system IEEE 802.11b. Furthermore, most mobile stations support the Bluetooth system, which provides a short-range radio access. In addition to these radio access schemes, some mobile stations may be capable of a wireline connection, e.g. when connected to a docking station, whereby the RF parts of the mobile station may be switched off and the network connection is handled via a wired access scheme. Accordingly, it should be noted that the invention is not limited to mobile stations, but it is also possible to apply the invention to portable or fixed personal computers, portable digital assistant (PDA) devices, and other electronic devices.

The mobile station MS comprises a central processing unit (CPU), memory (MEM), and I/O system (I/O). All necessary information is stored in the memory (MEM) of the device. The memory (MEM) comprises a read-only memory section formed for instance of a ROM memory, and a read-write memory section formed for instance of a RAM (Random Access Memory) and/or FLASH memory. Through the I/O system (I/O), the device communicates for instance with other devices, the network and the user. In particular, the I/O system comprises at least one transceiver unit Tx/Rx arranged to transmit and receive data transfer according to various wireless data transfer protocols through at least one antenna Ant. It should be noted that the number of transceiver units and antennas in a multi-access mobile station is design-dependent, and a multi-access mobile station can be implemented even with one transceiver unit and one antenna. A user interface (UI), which is part of the I/O system (I/O), comprises the necessary interface, such as a display, keys, loudspeaker, and/or microphone, for communicating with the user. Information received from the different components of the device is transmitted to the central processing unit (CPU) that comprises one or more processors and processes the received information as desired.

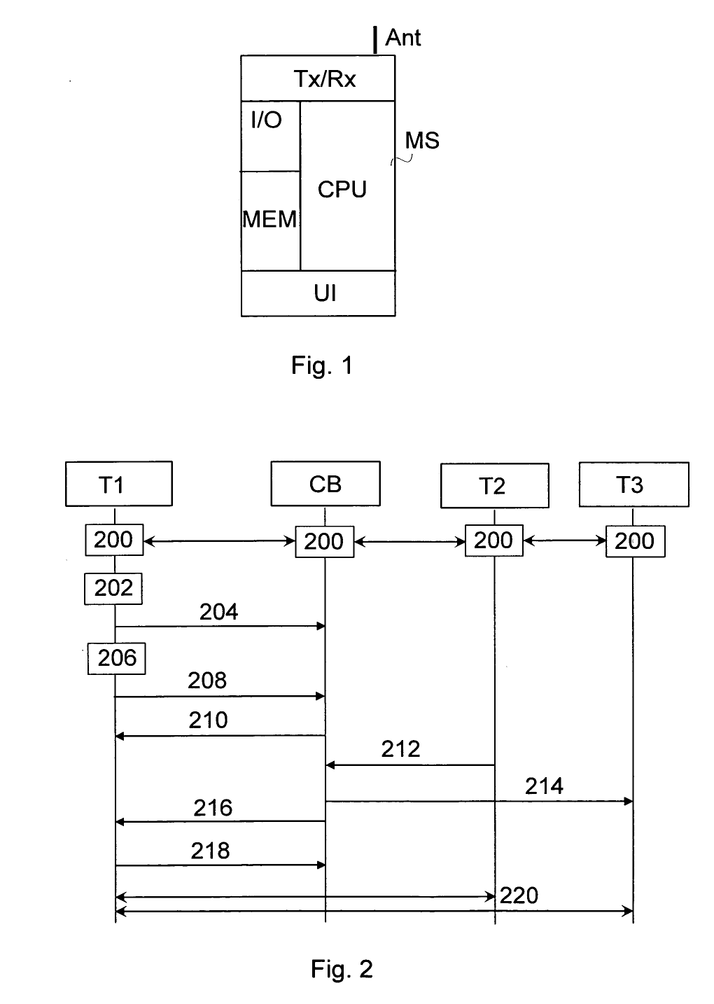

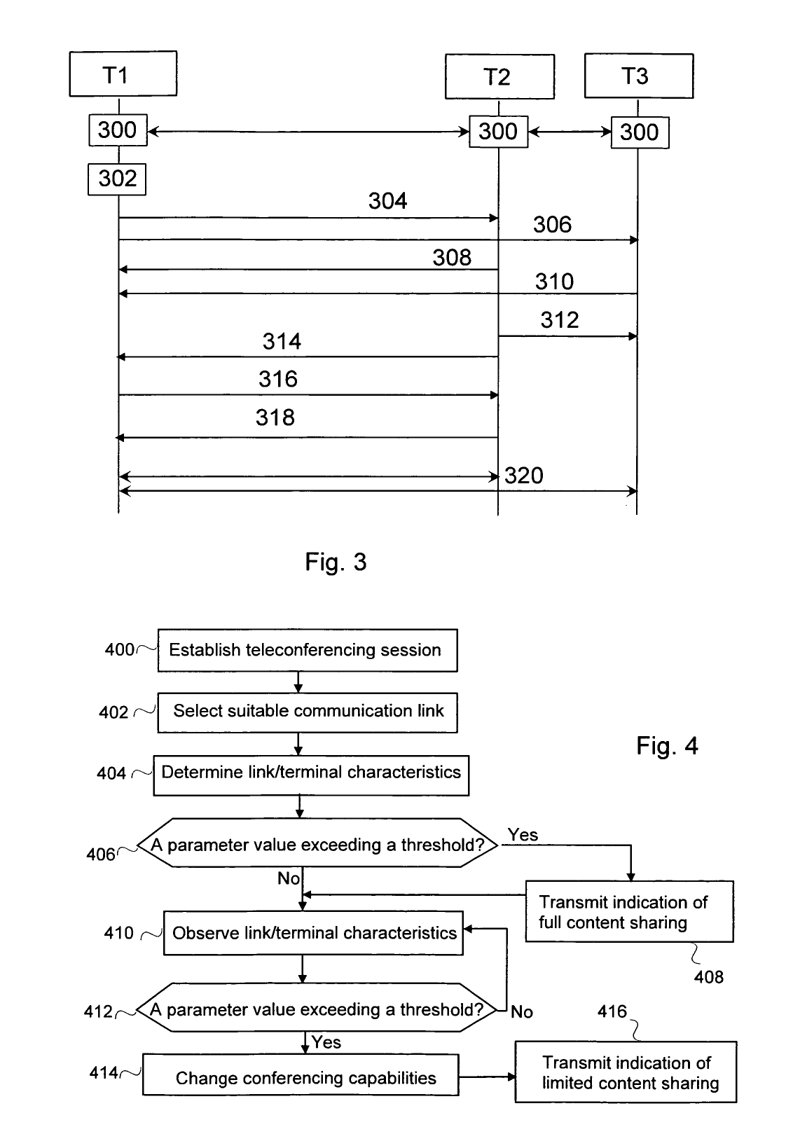

In a mobile conferencing session, there are at least two devices involved: terminal 1 and terminal 2 of the two participants. As noted above, the terminals may be desktop/laptop PCs, mobile phones, etc. Depending on whether a centralized or a distributed conferencing system is used, the conferencing session may include a conference bridge that controls the conferencing session and is able to connect the participants to the conferencing session. Next, these two alternatives are further discussed in connection with two embodiments of the invention, illustrated in FIG. 2 and FIG. 3.

According to an embodiment of FIG. 2, the terminals T1, T2, T3 establish a conferencing session in a centralized conferencing system comprising a conference bridge CB. In the following, the features of the embodiment are discussed from the viewpoint of terminal T1; the other terminals T2 and T3 may naturally carry out the same actions, even though they are not explicitly disclosed herein. The establishing of the conferencing session between the terminals is not disclosed in FIG. 2, since a skilled man is familiar with the procedure and the establishing of the conferencing session, as such, is beyond the scope of the invention.

Accordingly, as a starting point of FIG. 2 there is an established conferencing session (200) between the terminals T1, T2, T3. Terminal T1 determines (202), either simultaneously with the establishing of the conferencing session or shortly after that, the characteristics of the link it has established for the conferencing session. The link characteristics may include e.g. type of access technology (e.g. cellular/WLAN/wired connection), various QoS parameters, like bitrate, end-to-end delay and error rate, etc. In the determination of the link characteristics, terminal T1 may use the assistance of another device, e.g. the conference bridge CB, whereby the perceived characteristics of the communication link of terminal T1 can be determined. The conference bridge itself may also observe the link characteristics and send link characteristics information to the terminal T1. The conference bridge CB may also receive link characteristics information from other terminals T2 and T3, and transfer relevant information to the terminal T1, whereby the terminal T1 may better determine the overall link characteristics.

If it is noticed in the terminal T1 that the link characteristics reach or exceed one or more predefined criteria, the terminal T1 may indicate (204) to the conference bridge CB that it is willing to receive and transmit all kinds of content during the conference session. According to an embodiment, the full content sharing may be a default setting both in the terminal T1 and in the conference bridge CB, whereby there is no need for a specific indication, but the operation is always started with the full content sharing unless otherwise indicated.

The terminal T1 and/or the conference bridge CB continuously observe (206) the link characteristics or possible changes in the operating status of the terminal T1 or both. If a certain parameter of the link characteristics drops below a predefined criterium, e.g. bitrate is reduced when a WLAN connection is changed to WCDMA/EDGE, the terminal T1 changes its conferencing capabilities accordingly, i.e. the terminal T1 refuses to accept full content sharing. Then the terminal preferably notifies the conference bridge CB that it is willing to receive only limited content according to certain requirements. In the example of FIG. 2, in response to the bitrate reduction, the terminal T1 indicates (208) to the conference bridge CB that only speech and chat services are allowed, but for example no document sharing. The conference bridge CB then preferably acknowledges (210) this request of limited sharing, after which the conference bridge CB is able to control what kind of conferencing services and options are applied to terminal T1.

Also possible changes in the operating status of the terminal T1, which are not related to any link characteristics, may cause a change in the conference service status. For example, if the battery level or the available CPU power of the terminal T1 drops below a certain threshold, some conferencing services, like chat or document delivery, may be refused. Furthermore, some static properties of the terminal T1 may cause a change in the conference service status. For example, the terminal T1 may not support some service, like document browsing or chat, whereby it may not be desired to receive messages relating to such a service. Various examples of the static properties or the changes in the operating status of the terminal T1, which may cause a change in the conference service status, are explained further below.

The possible changes in the link characteristics or in the operating status of the terminal T1 may also reflect to a situation, wherein the terminal T1 has some content to share with other participants of the conferencing session. Likewise, if the battery level or the available CPU power of the terminal T1 or the bitrate of used communication link drops below a certain threshold, the terminal T1 may totally refrain content sharing towards other parties of the teleconferencing session.

Then in the example of FIG. 2, the terminal T2 sends (212) a text document to the conference bridge CB for further sharing between the participants of the conferencing session. However, due to the denial of document sharing from the terminal T1, the document is only sent (214) to the terminal T3. According to an embodiment, the conference bridge CB may send (216) a request to the terminal T1, whether this particular document should be sent to the terminal T1 or whether it should be stored in the conference bridge CB or in the terminal T2 for a later delivery, e.g. when a better access network is available for the terminal T1. In the example of FIG. 2, the terminal T1 nevertheless denies (218) the document delivery and storing, after which only speech and chat services are applied to terminal T1. Terminal T1 continues (220) the ongoing speech conferencing, and later on, if the parameters of the link characteristics or in the operating status of the terminal T1 (e.g. a battery charger is connected to the terminal T1) are restored to satisfactory values, the terminal T1 may again notify the conference bridge CB that the full content sharing or at least enhanced content sharing is now allowed.

According to an embodiment, the service level of content sharing towards the terminal may also change gradually, depending on one or more parameter values of the link characteristics or in the operating status of the terminal. Thus, when a parameter value of e.g. bitrate degrades below a certain level, sharing of content requiring wide bandwidth may be denied. Then, when another parameter, such battery status, degrades below a certain level, sharing of all other content but voice conferencing may be denied, for example. In the same way, the service level of content sharing towards the terminal may also be enhanced gradually, when a certain parameter value rises above a given threshold. For example, connecting a battery charger to a terminal having low battery status may enhance the service level of content sharing. Then, when the bitrate becomes high enough, full content sharing may be allowed.

The above signalling example can be illustrated with a use case, wherein a user of the terminal T1 sits in a train waiting for the train to leave from a train station. The user of the terminal T1 participates a conference meeting using a WLAN connection, which is available via a WLAN hotspot located at the train station. The terminal T1 is a PDA device with very advanced properties, and thus the user has configured the full content sharing as a default setting. Accordingly, the user is enabled to listen, speak, chat and receive all shared material. When the train leaves the train station, the WLAN connection is lost and the conferencing session is handed over to a WCDMA connection. As a result of the handover, data transfer becomes more expensive and slower. Thus, the user wants to keep on the voice connection and the chat service, but any other content sharing is denied. The terminal T1 notifies the conference bridge CB that no shared data content should be delivered to the terminal T1 until further notice. When some other participant of the conference meeting shares a document, the conference bridge CB distributes the document to the willing participants, but for the terminal T1, the conference bridge CB blocks the content delivery or separately requests a permission to deliver the content.

According to an embodiment of FIG. 3, the terminals T1, T2, T3 establish a conferencing session in a distributed teleconferencing system, wherein separate output signals are created, each of the output signals representing speech and other content sharing of one participant of the conferencing session. In a distributed teleconferencing system, a conference bridge may be used to gather the output signals of each participant and to forward them to other participants, but provided that the terminals participating the conferencing session possess required intelligence, no conference bridge is necessarily needed in a distributed teleconferencing system. In the embodiment of FIG. 3, the teleconferencing system does not include a conference bridge.

Again, the starting point of FIG. 3 is an established conferencing session (300) between the terminals T1, T2, T3. In this case, the terminal T1 has the full content sharing as a default setting, and the conferencing session is started with the assumption that the link characteristics are satisfactory. However, the terminal T1 soon notices, after started to continuously observe (302) the link characteristics and possible changes in the operating status of the terminal T1, that at least one parameter (e.g. bitrate) of the link characteristics has declined below a predefined criterium. Again, in the determination of the link characteristics, terminal T1 may use the assistance of another terminal T2 and/or T3, whereby the perceived characteristics of the communication link of terminal T1 can be determined.

Consequently, the terminal T1 changes its conferencing capabilities accordingly, i.e. refuses to accept full content sharing. Then the terminal T1 preferably notifies the other participants of the conferencing session that it is willing to receive only limited content according to certain requirements. In the example of FIG. 3, in response to the bitrate reduction, the terminal T1 indicates (304, 306) both terminals T2 and T3 that only voice conferencing is allowed, but no other content sharing. The terminals T2 and T3 then preferably acknowledge (308, 310) this request of limited sharing, after which the terminals T2 and T3 are able to control the content sharing they apply towards terminal T1.

The terminal T2 sends (312) an audio clip to be shared with the other participants of the conferencing session. However, due to the denial of content sharing from the terminal T1, the audio clip is only sent to the terminal T3. According to an embodiment, the terminal T2 may send (314) a request to the terminal T1, whether the terminal T1 wishes to receive the audio clip, either immediately or at a later phase. In the example of FIG. 3, the user of the terminal T1 finds this audio clip interesting and, despite the degraded bitrate, decides to receive it. Accordingly, a reply message with the acceptance is sent (316) to the terminal T2, which then sends (318) the video clip to the terminal T1. Thereafter, the terminal T1 continues (320) only the ongoing speech conferencing, and the previously configured limitations on the content sharing still apply. Then later on, if the parameters of the link characteristics are restored to satisfactory values, the terminal T1 may again notify the terminals T2 and T3 that the full content sharing is now allowed.

These two examples elucidate clearly the significant advantages provided by the embodiments of the invention. The multi-access awareness provided by the embodiments takes into account the possibly changing link characteristics of a multi-access terminal, thus facilitating to control the content sharing to better reflect the current link characteristics. In addition to link characteristics, the embodiments also provide means for controlling the content sharing according to (either stable or varying) characteristics of the terminal, which characteristics also reflect to the smoothness of the content sharing. As a result of these control means of the embodiments, the content sharing during a teleconferencing session can advantageously be enhanced and optimized.

A further system, wherein a group call enabling also content sharing can be established, is a so called push-to-talk over cellular (PoC) network. The PoC systems are based on the idea that the group communication service is provided as a packet-based user or application level service so that the underlying cellular network (e.g. a GSM/GPRS/UMTS network) only provides the basic connections (i.e. IP connections) between the group communications applications in the user terminals and the group communication service. The group communication services are typically provided as Voice over IP (VoIP) solution carried over GPRS/UMTS packet data network. The group communication application can then be implemented as a client-server solution, wherein the communication network provides a group communication server system while the group client applications reside in the user equipments or terminals. Accordingly, the packet-switched connections used in the PoC systems can also be used to share data content during a group call, and the group communication server system of the PoC networks functions as a teleconferencing bridge.

As noted above, the conferencing service properties provided for a terminal may be affected by the used access technology. In case of a multiradio mobile station participating in mobile conferencing, the mobile station tries to choose the most optimum access technology to be used. For example, a WLAN hotspot may offer a high-quality and an inexpensive connection, when the user of the terminal stays within the coverage area of the WLAN. Since the QoS of the network connection fulfils predefined criteria, e.g. an adequate bitrate, the user may fully participate into mobile conferencing. However, when the QoS of the network connection changes, e.g. the user goes out from the WLAN hotspot and the network connection is handed over to EGSM, the user may want to access the mobile conference only in a limited way. For example, if the bitrate of the network connection goes under a predefined threshold, the user may want to sustain the speech connection, but to refrain from other sharing activities. Otherwise the low bitrate connection could be blocked with the data and the usability would be disturbed.

Furthermore, the conferencing service properties provided for a terminal may be affected by the terminal capabilities and other characteristics. Some examples of these characteristics are discussed herein briefly.

The battery status of the terminal may change the mobile conferencing characteristics. Using multiple applications of the terminal simultaneously and different access technologies consumes the battery significantly. When the battery level drops below a certain threshold, some less important conferencing services, like chat or data content delivery, could be dropped to prevent the terminal to run out of battery too soon. If the terminal with a low level battery is connected to a battery charger during the conferencing session, the conferencing service level can be restored again.

Likewise, the available CPU power may vary in the terminal participating in mobile conferencing. Again, using multiple applications of the terminal simultaneously and different access technologies may reduce the CPU power to the extent that it is advisable not to accept some predefined content shared during the conferencing due to lack of the CPU power for processing the content. Alternatively, the content may be received, but it is only stored in a memory of the terminal and then processed later on.

In the same manner, available memory may change the mobile conferencing characteristics by limiting the content that may be stored in the terminal or applications that may be run during the conferencing.

Docking station availability may alleviate the above-mentioned limiting factors, and thus change the mobile conferencing characteristics. For example, when a terminal is connected to a docking station, it may provide more CPU power, more memory, battery charging function, a wireline connection with better link characteristics, etc. Accordingly, connecting the terminal to the docking station may enable the limited conferencing service level to be restored to more enhanced service level.

Also other terminal properties may change the mobile conferencing characteristics. Depending on the terminal model, the terminal may not support some service, like chat service or browsing of document files or power points. Thus, it is not desirable to receive content belonging to such a service. Furthermore, the terminal may not support some protocol required for conferencing, such as Mobile IP or another protocol. Lack of Mobile IP prevents seamless roaming between different access technologies and networks where IP address changes.

Available security mechanisms may change the mobile conferencing characteristics. For example, if the conferencing session is established via a secured VPN connection with adequate access technology security (e.g. WEP (Wired Equivalent Privacy) in WLAN), full content delivery can then be enabled. If limited or no security mechanisms are available, most sensitive content delivery can then be denied to prevent eavesdropping. Content delivery may also be subject to authentication such that content is accepted, if delivered from a trusted source. Blocking of untrusted content may take place already at the peer device, i.e. in the conference bridge or in another terminal, wherein the blocking may include an earlier step of the terminal informing the peer device that a predefined content is not accepted from a predefined participant.

As an aspect of the available security mechanisms, also the location of the terminal may change the mobile conferencing characteristics. When the terminal is located in a ‘home’ office building (or some other ‘safe area’) and using an office network, full content delivery can be enabled. When moving outside the safe area, only limited content delivery may then be enabled due to various reasons (untrusted network, pricing issues, privacy issues, etc.). As a further aspect of the security issues, also content coming from a predefined domain, identified e.g. with an IP address, may be accepted.

Time and/or date of the conferencing session may change the mobile conferencing characteristics. The primary reason derives from pricing issues; content delivery may be cheaper e.g. after 10 pm or during weekends, and therefore full content delivery may be enabled only then.

Peripheral devices connected to a terminal may change the mobile conferencing characteristics. For example, some handheld terminals have a very small display, which is not viable in browsing large documents or data files. Accordingly, sharing of large documents, powerpoints, etc. may only be enabled, when the terminal has been connected to an external larger display unit (TV, PC, etc.) to display the content. If no external larger display unit is available, the defined content can either be blocked or delivered immediately or later on (e.g. when better access technology is available), stored in the memory of the terminal and displayed later on when there is a better UI available. Other peripheral devices, which may facilitate content sharing and browsing during a conferencing session, and which devices when connected to the terminal may change the mobile conferencing characteristics are, for example, an external mass storage device, an external keyboard and external audio device.

The availability of these peripheral devices may be enhanced to a more generalized rule affecting the browsing or consumption of the content such that if the link characteristics or the internal status of the terminal restricts immediate content consumption, the content is stored into the terminal and browsed (i.e. displayed, playbacked, etc.) only later on when these restrictions do not apply any more. Likewise, if there is not enough bitrate available, a non-real-time delivery can be used and the content is shown later on, if there is not enough CPU power available, the content may be stored but it is not displayed immediately, etc. The terminal is preferably configured to control internally the content consumption, i.e. the delivery of the content is not affected, only how it is treated in the terminal.

Some predefined user activity on the terminal may change the mobile conferencing characteristics. For example, if a user of a PDA device participates in a conferencing service and then closes the PDA side while keeping the voice conferencing service active, it is an indication that the user wishes to only participate to the audio conference, but not to view or browse any other material. Accordingly, the terminal may control the content of the other material, whether it is accepted and if accepted, how the content is to be delivered, i.e. is the real-time reception necessary or can the content be delivered later on or in a background mode without any real-time requirements.

In many terminals, it is possible to define several user profiles, i.e. a group of user-dependent settings, for different users. Consequently, the user profile may change the mobile conferencing characteristics; a first user of the terminal may have access to full conferencing services whereas a second user may have access only to limited conferencing services.

In a wireless terminal, the functions of the invention can preferably be implemented by software SW downloaded to the terminal, which, when executed in the central processing unit CPU, makes the mobile station MS to perform actions according to the invention. The functions of the software SW can be distributed to several separate software components that communicate with each other. The software can be stored on any storage medium, such as the hard disk of a PC or a CD-ROM disk, from which it can be downloaded to the memory MEM of the terminal MS. The software can also be downloaded through the network by using a TCP/IP protocol stack, for instance. It is also possible to use hardware solutions or a combination of hardware and software solutions to implement the inventive means.

Thus, the software SW1, by means of which the terminal T1 controls the content sharing during a conferencing session may preferably comprise a computer program code section, such as a sub-process, for establishing the teleconferencing session with at least a second terminal; a computer program code section for selecting a communication link having suitable link characteristics for sharing desired content during the teleconferencing session; a computer program code section for observing changes occurring in the link characteristics of the communication link or in internal characteristics of the first terminal; and a computer program code section, responsive to at least one predetermined parameter value of said link characteristics or said internal characteristics of the first terminal reaching a predetermined threshold, for transmitting an indication to the conference bridge that the content sharing towards the first terminal is to be limited according to a rule included in said indication.

The operation of the software SW and the terminal T1 it controls can yet be illustrated by means of the flow chart of FIG. 4. First, the user of the first terminal T1 establishes (400) the teleconferencing session with a second terminal. After detecting available access networks, the first terminal may select (402) a communication link having suitable link characteristics for sharing desired content during the teleconferencing session. Optionally, the first terminal may determine (404) the link characteristics of the communication link and/or some internal characteristics of the terminal, and if at least one predetermined parameter value of said characteristics reaches or exceeds (406) a predetermined threshold, then transmit (408) an indication to the conference bridge or to the second terminal that the full or at least enhanced content sharing towards the first terminal is to be applied. However, as noted above, the full content sharing may be a default option, whereby no separate indication is needed.

Thereafter, the first terminal continually observes (410) possible changes occurring in the link characteristics of the communication link or in internal characteristics of the terminal, and if at least one predetermined parameter value of said link characteristics or said internal characteristics of the first terminal reaches or exceeds (412) a predetermined threshold, the terminal changes (414) its conferencing capabilities accordingly. Then the terminal optionally transmits (416) an indication either to the teleconferencing bridge or to the second terminal that the content sharing towards the first terminal is to be limited according to a rule included in said indication.

It should be evident that the present invention is not limited solely to the above-presented embodiments, but it can be modified within the scope of the appended claims.

1. A method for controlling content sharing towards a terminal during a teleconferencing session, the method comprising:
establishing the teleconferencing session between at least a first terminal and a second terminal;
selecting, for the first terminal, a communication link having suitable link characteristics for sharing desired content during the teleconferencing session;
observing, in the first terminal, changes occurring in the link characteristics of the communication link or in internal characteristics of the first terminal;
in response to at least one predetermined parameter value of said link characteristics or said internal characteristics of the first terminal reaching a predetermined threshold, changing a conferencing capability of the first terminal.

2. The method according to claim 1, the method further comprising:
transmitting an indication to at least one party of the teleconferencing session or to a conferencing bridge that the content sharing towards the first terminal is to be limited according to a rule included in said indication.

3. The method according to claim 2, the method further comprising:
determining the link characteristics of the communication link in connection with establishing the teleconferencing session;
and in response to at least one predetermined parameter value of said link characteristics or said internal characteristics of the first terminal exceeding predetermined threshold, transmitting an indication to at least one party of the teleconferencing session or to the conferencing bridge that enhanced content sharing towards the first terminal is to be applied.

4. The method according to claim 3, the method further comprising:
determining the link characteristics of the communication link with assistance of at least one party of the teleconferencing session.

5. The method according to claim 2, the method further comprising:
in response to a party of the teleconferencing session having content to be shared, sharing of which content towards the first terminal being refused by the rule,
receiving, in the first terminal, a request from said party or from the conference bridge for allowing transmission of the particular content to the first terminal.

6. The method according to claim 1, the method further comprising:
in response to at least one predetermined parameter value of said link characteristics or said internal characteristics of the first terminal reaching or exceeding said predetermined threshold,
refraining content sharing from the first terminal towards other parties of the teleconferencing session.

7. The method according to claim 1, wherein the parameter value of said link characteristics include at least one of the following:
used access technology,
connection type,
one or more quality of service parameters, and
time or date, or both time and date of the conferencing session.

8. The method according to claim 1, wherein the parameter value of said link characteristics include at least one of the following security issues:
existence of a security mechanism on an established communication link,
location of an access point of the communication link,
location of the terminal, and
originating network address of shared content directed towards the terminal.

9. The method according to claim 1, wherein the parameter value of said internal characteristics of the terminal include at least one of the following:
battery status,
available CPU power,
available memory space,
docking station connected/not connected,
battery charger connected/not connected,
available peripheral devices, and
occurrence of a predefined user activity.

10. A teleconferencing system comprising a conference bridge and at least a first and a second terminal with means for sharing content, wherein:
the first and the second terminal are arranged to establish the teleconferencing session between each other via the conference bridge; and at least the first terminal comprising
means for selecting a communication link having suitable link characteristics for sharing desired content during the teleconferencing session; means for observing changes occurring in the link characteristics of the communication link or in internal characteristics of the first terminal; and
means, responsive to at least one predetermined parameter value of said link characteristics or said internal characteristics of the first terminal reaching a predetermined threshold, for changing a conferencing capability of the first terminal.

11. The system according to claim 10, wherein the first terminal further comprises:
means for transmitting an indication to the conference bridge that the content sharing towards the first terminal is to be limited according to a rule included in said indication.

12. The system according to claim 10, wherein the first terminal further comprises:
means for determining the link characteristics of the communication link in connection with establishing the teleconferencing session; and
means, responsive to at least one predetermined parameter value of said link characteristics or said internal characteristics of the first terminal reaching or exceeding said predetermined threshold, for transmitting an indication to the conference bridge that enhanced content sharing towards the first terminal is to be applied.

13. The system according to claim 12, wherein
the first terminal is arranged to determine the link characteristics of the communication link with assistance of the conference bridge.

14. The system according to claim 10, wherein:
in response to a party of the teleconferencing session having content to be shared, sharing of which content towards the first terminal being refused by a rule,
said party or the conference bridge is arranged to transmit a request to the first terminal for allowing transmission of particular content to the first terminal.

15. The system according to claim 10, wherein:
in response to at least one predetermined parameter value of said link characteristics or said internal characteristics of the first terminal reaching or exceeding said predetermined threshold,
the first terminal is arranged to refrain content sharing towards other parties of the teleconferencing session.

16. A terminal comprising:
means for sharing content during a teleconferencing session;
means for establishing the teleconferencing session with at least a second terminal;
means for selecting a communication link having suitable link characteristics for sharing desired content during the teleconferencing session;
means for observing changes occurring in the link characteristics of the communication link or in internal characteristics of the first terminal; and
means, responsive to at least one predetermined parameter value of said link characteristics or said internal characteristics of the first terminal reaching or exceeding a predetermined threshold, for changing a conferencing capability of the terminal.

17. The terminal according to claim 16, further comprising:
means for transmitting an indication to a conference bridge or to a party of the teleconferencing session that the content sharing towards the first terminal is to be limited according to a rule included in said indication.

18. The terminal according to claim 17, further comprising:
means for determining the link characteristics of the communication link in connection with establishing the teleconferencing session; and
means, response to at least one predetermined parameter value of said link characteristics or said internal characteristics of the first terminal exceeding predetermined threshold, for transmitting an indication to the conference bridge or to a party of the teleconferencing session that the enhanced content sharing towards the first terminal is to be applied.

19. The terminal according to claim 18, wherein
the terminal is arranged to determine the link characteristics of the communication link with assistance of the conference bridge.

20. The terminal according to claim 16, further comprising:
means, responsive to at least one predetermined parameter value of said link characteristics or said internal characteristics of the first terminal exceeding predetermined threshold, for refraining content sharing towards other parties of the teleconferencing session.

21. The terminal according to claim 16, wherein the parameter value of said link characteristics include at least one of the following:
used access technology,
connection type,
one or more quality of service parameters, and
time or date or both time and date of the conferencing session.

22. The terminal according to claim 16, wherein the parameter value of said link characteristics include at least one of the following security issues:
existence of a security mechanism on an established communication link,
location of an access point of the communication link, and
originating network address of shared content directed towards the terminal.

23. The terminal according to claim 16, wherein the parameter value of said internal characteristics of the terminal include at least one of the following:
battery status,
available CPU power,
available memory space,
docking station connected/not connected,
battery charger connected/not connected,
available peripheral devices, and
occurrence of a predefined user activity.

24. A computer program product, stored on a computer readable medium and executable in a data processing device, for controlling content sharing towards a terminal during a teleconferencing session, the computer program product comprising:
a computer program code section for establishing the teleconferencing session with at least a second terminal;
a computer program code section for selecting a communication link having suitable link characteristics for sharing desired content during the teleconferencing session;
a computer program code section for observing changes occurring in the link characteristics of the communication link or in internal characteristics of the first terminal; and
a computer program code section, responsive to at least one predetermined parameter value of said link characteristics or said internal characteristics of the first terminal reaching or exceeding a predetermined threshold, for transmitting an indication to a conference bridge or to a party of the teleconferencing session that the content sharing towards the first terminal is to be limited according to a rule included in said indication.
